(19) United States
(12) Patent Application Publication
(10) Pub. No.: US 2003/0068434 A1
(43) Pub. Date: Apr. 10, 2003

(54) Method for bonding thermoplastic films to metal surfaces of cylinders, vessels and component parts

(76) Inventor: James B. Moore, Centerville, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/224,751

(22) Filed: Aug. 20, 2002

Related U.S. Application Data
(60) Provisional application No. 60/313,977, filed on Aug. 21, 2001.

(51) Int. Cl. B05D 7/22; B05D 3/02; B05D 1/04; B05D 1/02

(52) U.S. Cl. 427/230; 427/475; 427/385.5; 427/421

(57) ABSTRACT

A method for treating at least a portion of an interior surface of a container comprises the steps of: (1) heating the interior surface of the container to a temperature suitable for melting a primer composition; (2) applying the primer to at least a portion of the interior surface of the container; (3) heating the treated portion of the container to the temperature suitable for melting the primer composition to facilitate bonding of the primer to the treated surface of the container; (4) delivering the thermoplastic material to the treated portion of the container; and (5) bonding the thermoplastic material by heating the treated portion of the container to a temperature suitable for melting the thermoplastic material. The application of the primer and the thermoplastic material are preferably applied to the portion of the interior surface of the container by electrostatic powder deposition and/or liquid dispersion. In addition, the method of the present invention may further include one or more of the following steps: (1) smoothing and cleaning the interior surface of the container prior to preheating the container before application of the primer composition and (2) delivering and bonding one or more additional applications of the thermoplastic material to the treated portion of the interior surface of the container.

### BACKGROUND

1. Related Application

This application claims the benefit of U.S. Provisional Application No. 60/313,977, filed Aug. 21, 2001 and entitled “THE BONDING OF THERMOPLASTIC FILMS TO METAL SURFACES OF CYLINDERS, VESSELS AND COMPONENT PARTS,” which is hereby incorporated herein by reference.

2. The Field of the Invention

The present invention relates to treating metal surfaces and, more particularly, to novel methods for applying a primer and thermoplastic material to at least a portion of a contact surface of metal containers, cylinders, vessels or component parts by means of application by electrostatic powder deposition, liquid dispersion and/or roto-lining.

3. Brief Description of the Art

A thermoplastic is generally defined as material with a linear macromolecular structure that will repeatedly soften when heated and harden when cooled, such as any organic polymer that is a solid at room temperature and melts above room temperature. For example, fluoropolymers, polyamide, polyphenylsulfone (PPF), polyether-etherketone (PEEK), polyethylenes and polypropylenes are generally classified as thermoplastics.

As appreciated by those skilled in the art, thermoplastics have been found to have excellent chemical resistance, generally good surface smoothness and low extractable properties which make them, especially fluoropolymers (an organic polymer that contains one or more fluorine atoms in the molecule), ideally suited for high purity applications, for example, in the chemical, nuclear, pharmaceutical and semiconductor industries.

Metal cylinders, vessels or component parts that may be used for receiving the application of thermoplastics are generally referred to in the art as a “substrate.” Typically, the bond is very weak between the substrate and some thermoplastic materials. In the absence of a strong bond between the thermoplastic material and the substrate, delamination will usually occur under conditions of vacuum, temperature cycling and/or at elevated temperatures. As appreciated by those skilled in the art, delamination may render the treated metal vessel, cylinder or component part unprotected and therefore useless, thus imposing costly down-time for repair and/or replacement.

Today, most industries, and especially the pharmaceutical and semiconductor sectors and/or users of most manufactured goods, are demanding that the products they consume should be ultra pure. It does not typically matter as to the form (e.g., gaseous, liquid or solid), purity is a primary issue. Importantly, it is known in the art that the storage container or vessel, especially if formed of metal, may be a potential source of product contamination, often referred to as ion contamination, whereby metallic ions are released from the metal substrate into the contents.

In an effort to eliminate the problems associated with lack of maintaining purity within at least a portion of the internal periphery of containers, those skilled in the art developed methods and techniques for applying thermoplastic linings to the contact surfaces of metal containers and vessels, thereby forming a barrier layer between the contents and the inner surfaces of the metal containers. Metallic ions do not readily permeate this barrier layer and many of the thermoplastics used in this lining process, are by nature pure, so the container or vessel contents remain pure. As can be appreciated by those skilled in the art, the barrier layer generally inhibits or eliminates cross contamination between the container and the contents.

Containers or vessels that are used to hold gas or liquid, having their inner surfaces covered with a polymeric coating, are well known in the art. The inner polymer coating applied to these containers may be provided in an effort to prevent corrosion of the container walls by the particular liquids or gases contained therein.

For example, a steel cylinder for holding high purity gases may be treated to provide a uniform polymeric coating on the internal surfaces of the cylinder. As appreciated by those skilled in the art, polyamides and polyolefins such as polyethylene and polypropylene are suitable polymeric materials that may be used. Moreover, the polymeric materials may be subjected to a fluorination step to further improve the barrier properties of the polymeric materials. There are, however, disadvantages associated with the fluorination steps of the lining process. Particularly, the separate fluorination treatment generally increases the overall cost of the treated container or vessel and may introduce unwanted impurities into the container. As appreciated, the top surface of the polymeric layer is usually the portion that is treated, while the rest of the layer is unaffected.

It has also been believed that certain high purity gases can easily penetrate polyethylene or polypropylene layers and cause corrosion to the underlying metal walls of the container or vessel. The by-products of such corrosion may then migrate back through the polyethylene or polypropylene layer and ultimately become unwanted impurities in the high purity gas housed within the container or vessel.

Alternative methods and techniques have been developed by those skilled in the art which include storing hydrogen bromide and hydrogen chloride gases in carbon steel or in the presence of TEFLON, KEL-F, or HASTELLOY B material in an effort to resist corrosion. However, many types of TEFLON, KEL-F or other polymeric materials cannot be used as internal coating layers on steel cylinders because they are not suitable for rotational molding application operations. Because of the problems associated with internal polymeric coatings in steel cylinders, sellers of high purity gases have recently turned to using special non-corrosive metal cylinders such as, for example, nickel which have no internal coating layers. The cost of nickel cylinders and the like, however, is much higher than the cost of ordinary steel cylinders and is, therefore, generally cost prohibitive. The present invention provides a solution to the foregoing problems without incurring the high cost associated with using special non-corrosive metal cylinders.

Those skilled in the art further developed methods and techniques for rotationally lining steel cylinders for holding high purity gases. Such prior art roto-lining techniques were created to provide a generally uniform polymeric coating formed on the internal surfaces of these steel cylinders. Suitable polymeric materials used for roto-lining, for example, may include polyper-fluoroalkoxyethylene, copolymer of ethylene and chlorotrifluoroethylene, and copolymer of ethylene and tetrafluoroethylene and polypropylene.

There are disadvantages associated with the prior art roto-lining techniques. Specifically, it has been found that the lack of a primer layer between the fluoropolymer coating and the metal substrate may represent a source of mechanical weakness, particularly for an application where visual inspection is not readily feasible. In addition, during change in pressure, temperature or exterior deformation, the lack of a primer layer will typically result in flexing and bending and eventual delamination, thus becoming a source of contamination. It would be desirable, therefore, to provide an improved method, technique or process for bonding thermoplastic materials or resins to a contact surface of a metal cylinder which realizes the advantages of facilitating an environment of purity within the treated cylinder or vessel. Such methods or processes are disclosed and claimed herein.

### SUMMARY OF THE INVENTION

In accordance with the invention as embodied and broadly described herein, one presently preferred method or technique for coating at least a portion of an interior surface of a container comprises the steps of: (1) heating the interior surface of the container to a temperature suitable for melting a primer composition; (2) applying the primer to at least a portion of the interior surface of the container; (3) heating the treated portion of the container to the temperature suitable for melting the primer composition to facilitate bonding of the primer to the treated surface of the container; (4) delivering the thermoplastic material to the treated portion of the container; and (5) bonding the thermoplastic material by heating the treated portion of the container to a temperature suitable for melting the thermoplastic material. The method of the present invention may further include the step of delivering and bonding one or more additional applications of thermoplastic material to the treated portion of the interior surface of the container. Moreover, the steps of smoothing and cleaning the interior surface of the container prior to preheating the container so as to apply the primer composition are also contemplated herein as part of one presently preferred embodiment of the present invention. The application of the primer and the thermoplastic material are preferably applied to the portion of the interior surface of the container by electrostatic powder deposition and/or liquid dispersion.

As appreciated, the bond between the contact surface of a substrate and a thermoplastic film is typically very weak. In an effort to overcome the weakness of this bond, a bonding agent or “primer” is required to strongly adhere the thermoplastic film to the metal substrate. Characteristics of the bonding agent or primer may include, for example, but not by way of limitation: (1) the ability to not degas, (2) the ability to prevent ion migration, (3) generally as stable as thermoplastic resins, (4) provides strong bonding and/or (5) provides synergistic properties with the thermoplastic layer of film or material. As appreciated, in the absence of strong bonding between the thermoplastic film and the substrate, delamination may occur under conditions of vacuum, temperature cycling and/or at elevated temperatures. Delamination may, accordingly, ultimately render the metal vessel, cylinder or component part unprotected and therefore useless, thus imposing costly down-time for repairs and/or replacement.

As known in the art, thermoplastics form weak interfacial bonds when they are melted and cooled on a metal surface. In the absence of strong bonding between the polymer coating and the metal substrate, delaminating frequently occurs under applications of full vacuum, temperature cycling, elevated temperatures, or external deformation. Therefore the roto-lining of high pressure gas cylinders with polymer resins requires a bonding agent. This bonding agent is commonly referred to as the primer.

The primer, as contemplated herein, may include a blend of powders derived from the polymer resin and other organic and inorganic materials, each with a different melt point and density. In one presently preferred embodiment, the primer layer is usually between about 5 and 10 mils in thickness and facilitates adherence of the polymer top coat to the metal substrate. As appreciated, the polymer top coat comprises a pure layer of the selected polymer material applied over the primer layer. The thickness of the top coat is dependent on the selected polymer material, but can be in excess of 200 mils.

The primer cannot be applied to a vessel by a roto-lining process, because the rotational motion results in separation of the primer components before melting and adhesion can occur. When roto-lining of a primer is attempted the result is commonly an uneven distribution of the primer over the metal surface. The resulting liner has significant variations in thickness and will not provide the required corrosion protection.

Methods of applying a primer layer and a high-purity polymer top coat to the interior surface of containers, vessels, high-pressure gas cylinders, component parts and the like using electrostatic powder deposition or liquid dispersion are described herein. The resulting lining formed includes any polymer whose adhesive strength to the metal substrate is improved by the use of a primer. The containers, vessels or high-pressure cylinders or the like contemplated herein may be suitable for storage of high purity gas including, but not limited to, hydrogen chloride, tungsten hexafluoride, chlorine, hydrogen bromide, nitrogen trifluoride, silanes and boron trichloride. These pressurized vessels may also be suitable for service from a full vacuum to about 6,000 psig.

In one presently preferred embodiment of the present invention, the metal cylinder, vessel or component part (“substrate”) comprises an inner contact surface that is prepared for coating by grit blasting as per NACE No. 1, and cleaned and air dried to remove residual blasting medium. The inner contact surface of the substrate may then be coated with a bonding agent or primer in sufficient quantity, type and characteristic, so as to provide a strong bond between the thermoplastic coating or film and the contact surface of the metal substrate. As described in further detail hereinbelow, the bonding agent or primer may be applied by the technique of roto-lining/roto-molding or by means of electrostatic powder deposition (EPD) or liquid dispersion. Depending upon the application processes being used, as outlined above, the substrate may be preheated or heated after the application of the primer. Moreover, the thermoplastic material or film may be applied after or simultaneous with the application of the undercoat to the contact surface of the substrate, as desired. As appreciated, the inner contact surface of the metallic cylinder, vessel or component part may be exposed to negative pressure up to either vacuum or 6,000 psig and/or temperatures of about −40° C. to 150° C.

### DETAILED DESCRIPTION OF THE PREFERRED EMBODIMENTS

It will be readily understood that the following detailed description of the embodiments of the steps of the process, technique and method of the present invention is not intended to limit the scope of the invention, as claimed, but it is merely representative of the presently preferred embodiments of the invention.

The technique of roto-molding is basically identical to the technique of roto-lining except that, in the case of roto-lining, the liner is bonded to the contact surface of the vessel, whereas the liner is retrievable when using the process of roto-molding. Typically, the technique of roto-lining/roto-molding is used for film thicknesses of 120 mil to 250 mil.

In one presently preferred embodiment of the invention, the metal cylinder, vessel or component part is prepared for coating as per NACE No. 1 and then charged with an undercoat having an appropriate quantity, depending on the relevant size of the substrate and the lining thickness required.

The cylinder, vessel or component part may then be mounted on a machine that subjects the cylinder to motion in at least two perpendicular axes simultaneously, while being heated in an oven to above the melting temperature of the polymer, and as much as 38° C. above said melting point. The cylinder is preferably maintained at this constant temperature, for a specified length of time until the undercoat completely melts and flows to form a continuous layer of film that covers the contact surface of the inner walls of the metal cylinder.

The cylinder is then cooled to room temperature and the lining may then be inspected for any imperfections. As appreciated, the lining should be without voids and/or bubbles, and preferably have a uniform film thickness.

The thermoplastic material, preferably comprising a powder, may then be added over the previously applied undercoat. The powder may be selected from organic polymers that are solids at room temperature and melt above room temperature. For example, an organic polymer may be selected from the group consisting of fluoropolymers, such as, for example but not by way of limitation, ethylene chlorotrifluoroethylene (ECTFE), chlorotrifluoroethylene (CTFE), ethylene tetrafluoroethylene (ETFE), HTE, polyvinylidene fluoride (PVDF), fluorinated ethylene propylene (FEP), methylfluoroalkoxy (MFA), perfluoroalkoxy (PFA), copolymers and terpolymers of the aforementioned, or non-fluoropolymers, such as, for example but not by way of limitation, polyamide, polyphenylsulfone (PPF), polyether-etherketone (PEEK), polyethylene, and polypropylene.

The cylinder is then returned to the oven, rotated on two perpendicular axes simultaneously and heated at an appropriate temperature until the thermoplastic material melts and flows to form a continuous film. This is one presently preferred embodiment of the roto-lining process.

One presently preferred embodiment of the technique using electrostatic powder deposition (EPD) may be used to achieve film thicknesses from about 10 mil to 100 mil. This technique is commonly referred to in the industry as “powder coating.” The metal cylinder, vessel or component part (“cylinder”) is prepared for coating as per NACE No. 1 then preheated in an oven to a temperature suited to the primer and thermoplastic material being processed. The cylinder may then be removed from the oven, and the primer deposited by specialized feed equipment that adds a charge to the powder, opposite to the ground charge. For example, but not by way of limitation, if the specialized feed equipment adds a positive charge to the powder, the ground charge will be negative, or vice versa. This charge serves to adhere the primer to the contact surfaces of the inner walls of the cylinder, vessel or component part.

Alternatively, the thermoplastic resin powder is applied to the layer of primer applied to the contact surface of the inner walls of the cylinder. The cylinder is then returned to the oven and heated at an appropriate temperature until the combination primer/thermoplastic resin powder application melts and flows to form a first layer of the continuous film lining. The steps of applying additional thermoplastic resin powder and subsequent heatings in the oven are repeated, until the desired lining thickness is achieved.

The following examples are provided in an effort to illustrate one or more of the presently preferred embodiments of the novel apparatus and methods of the present invention for bonding thermoplastic films to metal surfaces of cylinders, vessels and component parts. It is intended, therefore, that the examples provided herein be viewed as exemplary of the principles of the present invention, and not as restrictive to a particular structure or process form implementing those principles.

### EXAMPLE I

### Technique Or Process For Roto-Lining/Roto-Molding

1. Prepare the cylinder to be roto-lined as per NACE No. 1 process for grit blasting to white metal finish prior to coating/lining.

2. Clean and air dry the contact surfaces of the inner walls of the cylinder to remove residual blasting medium.

3. Mount the cylinder onto the roto-lining/roto-molding machine.

4. Charge enough powder primer to line the part to an appropriate thickness. Close the cylinder with an end cap.

5. Rotate the cylinder in at least two perpendicular axes simultaneously while heating the cylinder in the oven at an appropriate temperature for a specified time.

6. Remove the cylinder from the oven and cool to room temperature.

7. Charge the specified amount of thermoplastic powder (resin) to the cylinder, then close the cylinder with the end cap.

8. Return the cylinder to the oven at the temperature specific to the resin being used, for a specified time, while rotating the cylinder on at least two perpendicular axes.

9. Cool the cylinder while continuing the rotation until the molten polymer solidifies.

10. Inspect the lining for bubbles, pinholes and defects that might render the lining defective.

### EXAMPLE II

### Technique for Electrostatic Powder Deposition (EPD) Procedure

1. Prepare the high-pressure gas cylinder to be coated according NACE No 1. grit blasting for white metal finish. This standard defines a white metal finish as a surface from which all rust and foreign materials are entirely removed. The surface when viewed without magnification shall be free of all oils, grease, dirt, visible mill scale, rust, corrosion products, oxides, paint and other foreign matter. The color of the clean surface may be affected by the particular abrasive medium used. Photographic or other visual standards of surface preparation may be used if required to further define the surface if specified in the contract.

2. Clean and air dry the high-pressure gas cylinder to remove residual blasting medium.

3. Preheat the high-pressure gas cylinder to the recommended process temperature for the resin being processed. The preheat is required to bring the part temperature up to the melting temperature of the resin. The resin manufacturers have listed in their brochures their suggested process temperatures for their resins. For example, but not by way of limitation: ETFE has a process temperature of about 305° C.; ECTFE has a process temperature of about 305° C.; and PVDF has a process temperature of about 260° C. A range of process temperatures for the resins used is between about 200° C. to 380° C. This process temperature is also influenced by the amount of comonomer.

4. The powder primer can now be applied using an electrostatic powder coating process. A typical powder primer is described as a composition suitable for use as a primer coating for a substrate which comprises a halopolymer, an epoxy resin, and an oxide of titanium. The epoxy resin and oxide of titanium are present in amounts effective to provide a primer coating of the composition over a substrate. Preferred halopolymers are ethylene/chlorotrifluoroethylene copolymers and terpolymers, and ethylene/tetrafluoroethylene copolymers and terpolymers. Preferred epoxy resins include bisphenol-A based epoxy resins and epoxy cresol novolac resins. A preferred oxide of titanium is titanium dioxide.

5. The electrostatic powder coating method begins when the powder in the apparatus holding tank is mixed with compressed air, which enables the powder-air mixture to be pumped from the container to the spray gun. This process is known as fluidization of the powder. The equipment used to powder coat is available from companies such as Gema or Nordson.

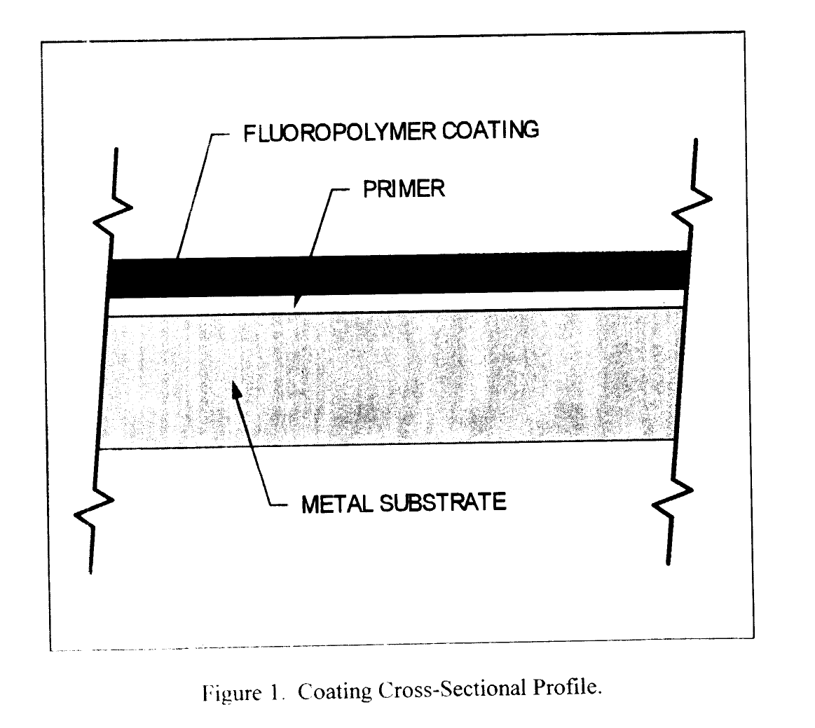

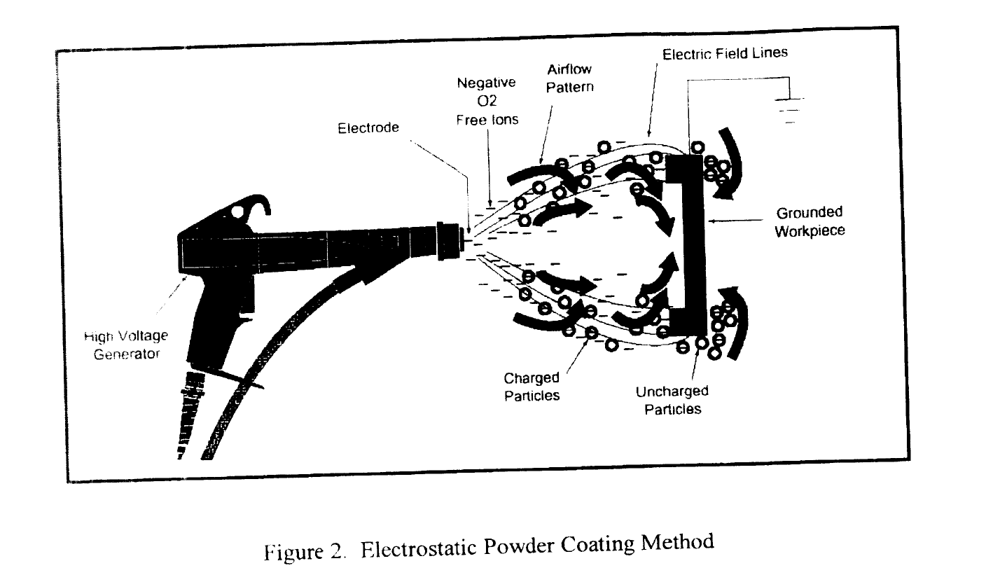

6. An electrostatic charge is applied to the powder as it is moves through the spray gun. With the help of the compressed air, the charged powder moves towards the grounded metal piece that will be coated. As the powder particles approach the part surface, an electrostatic interaction binds the powder to grounded metal substrate. This process is shown in FIG. 2:

7. Variables that can be controlled in the electrostatic powder coating process include air pressure in the fluidized bed, air pressure of the spray gun, and the strength of the electrical charge applied to the powder. Typical values for these settings on a Nordson brand gun as a function of powder material are shown as follows:

| | Fluidized Air Pressure | Gun Pressure | Electrical Charge |
|---|---|---|---|
| Polymer | (psi) | (psi) | (kV) |
| ETFE | 60 | 20 | 43 |
| ECTFE | 40 | 20 | 43 |
| PVDF | 20 | 0 | 0 |
| Polypropylene | 30 | 20 | 30 |

8. Changes to the air pressure in the fluidized bed, air pressure of the spray gun, and the strength of the electrical charge applied to the powder are used to control:

a. shape and direction of the powder flume;

b. pattern size and density of the powder flume;

c. strength of the electrostatic charge applied to the powder particles; and

d. thickness of the powder on the metal substrate.

9. After the primer has been applied to the high-pressure gas cylinder it is put back into the oven and allowed to melt and fuse onto the substrate. The amount of time in the oven must be controlled in order to avoid degradation of the primer layer and varies according to the part dimension.

10. After the primer has fused to the substrate, the high-pressure gas cylinder is removed from the oven and a topcoat is electrostatically powder coated to the surface. This process is identical to the procedure used to apply the primer layer.

11. The oven temperature is reduced to a temperature slightly above the melting point of the polymer topcoat. Typical values for the melting temperatures are shown in the respective manufacturers' literature. For example, but not by way of limitation: ETFE has a melting temperature range of between about 255° C.-280° C. according to Tefzel 207 Fluoropolymer Resin, DuPont Company Literature; ECTFE has a melting temperature of about 240° C. according to Halar ECTFE Design Guide, Ausimont Company Literature; and PVDF has a melting temperature range of between about 165° C.-170° C. according to Kynar and Kynar Flex PVDF—Performance Specifications and Data, Atofina Company Literature. A range of melting temperatures for the thermoplastics used is between about 150° C. to 320° C.

12. Apply the thermoplastic topcoat by the electrostatic powder-coating process and return the high-pressure gas cylinder to the oven.

13. Return the part to the oven and heat again at the recommended processing temperature until the powder is melted.

14. Repeat steps 12 and 13 until the desired thickness of the polymer lining is achieved.

### EXAMPLE III

### Technique for Liquid Dispersion Coating Procedure

1. Prepare the high-pressure gas cylinder to be coated according NACE No 1. grit blasting for white metal finish. This standard defines a white metal finish as a surface from which all rust and foreign materials are entirely removed. The surface when viewed without magnification shall be free of all oils, grease, dirt, visible mill scale, rust, corrosion products, oxides, paint and other foreign matter. The color of the clean surface may be affected by the particular abrasive medium used. Photographic or other visual standards of surface preparation may be used if required to further define the surface if specified in the contract.

2. Clean and air dry the high-pressure gas cylinder to remove residual blasting medium.

3. Preheat the high-pressure gas cylinder to the process temperature required to evaporate the solvent used in the dispersion coating. A dispersion is defined as finely divided particles of a material suspended in a liquid. The flash temperature is lower than the melting point of the thermoplastic material.

4. The liquid primer can now be applied using the dispersion coating process. There are five different methods used to apply a liquid coating to a surface and include conventional spraying, HVLP (High Volume, Low Pressure), airless, pressure pot, and electrostatic methods.

Conventional spraying is a method that uses pressurized air to atomize the liquid. HVLP is a method that reduces air pressure and increases liquid volume. Airless liquid spraying is a method that uses hydraulic pressure to move and atomize the liquid instead of air. Pressure pot liquid spraying is similar to conventional spraying except that the coating is under positive pressure. This technique exerts more pressure than a conventional system and is recommended for larger production runs. Electrostatic liquid spraying is recommended for very high production conditions or when an electrostatic “wrap” is needed to coat complex shapes efficiently. Rods, wires, outdoor furniture and other parts that require a 360-degree coating are examples.

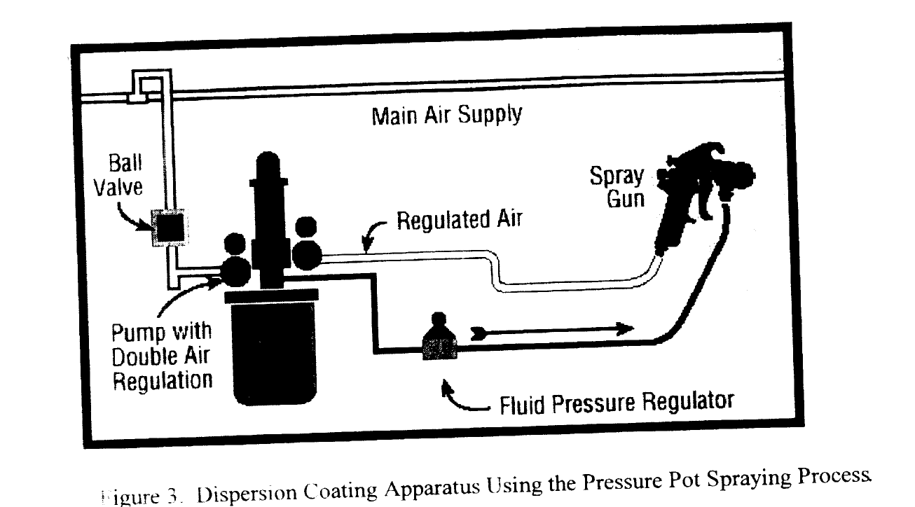

The equipment used for dispersion coating is typical industrial painting systems such as those available from Binks or Nordson. The typical equipment configuration for the pressure pot method is shown in FIG. 3:

5. Variables that can be controlled in the dispersion coating process vary depending on the method used, however changes in the system are used to control:

a. shape and direction of the liquid flume; and

b. pattern size and density of the liquid flume.

After the liquid primer has been applied to the high-pressure gas cylinder and the solvent carrier has evaporated, the oven temperature is raised above the melting point of the thermoplastic and the part is placed back into the where the thermoplastic melts and fuses onto the substrate. The amount of time in the oven must be controlled in order to avoid degradation of the primer and varies according to the part dimension. DuPont and Whitford sell fluoropolymer-based corrosion-resistant dispersion coatings in which cure temperatures, oven times, and coating methods vary greatly.

6. Once the coating has fused to the substrate, the high-pressure gas cylinder is removed from the oven. A liquid topcoat can now be applied using the dispersion technique over the primer surface. This process is identical to the procedure used to apply the primer layer.

7. The dispersion coating process consists of either a one-step or primerless system, or a two-step system with a primer and topcoat. A thicker layer may be achieved by subsequent spraying applications. Generally, not as thick as electrostatic powder deposition.

The present invention may be embodied in other specific forms without departing from its spirit or essential characteristics. The described embodiments are to be considered in all respects only as illustrative, and not restrictive. Those skilled in the art will readily recognize other possible modifications and adaptations which are consistent with the spirit and scope of the present invention.

What is claimed and desired to be secured by United States Letters Patent is:

1. A process for applying a primer and a thermoplastic material to at least a portion of an interior surface of a container, said process comprising the steps of:
heating said portion of said interior surface of said container to a first temperature;
applying said primer to said portion of said interior surface of said container by electrostatic powder deposition;
heating said treated portion of said container to said first temperature to facilitate bonding of said primer to said treated surface of said container;
delivering said thermoplastic material by electrostatic powder deposition to said treated portion of said container; and
bonding said thermoplastic material by heating said treated portion of said container to a second temperature.

2. The process as defined claim 1, further comprising the step of roughening said portion of said interior surface of said container.

3. The process as defined in claim 1, further comprising the step of cleaning said portion of said interior surface of said container to remove debris.

4. The process as defined in claim 1, further comprising the step of delivering a second application of said thermoplastic material by electrostatic powder deposition to said treated portion of said container.

5. The process as defined in claim 4, further comprising the step of bonding said second application of said thermoplastic material by heating said treated portion of said container to said second temperature.

6. The process as defined in claim 1, wherein said container is selected from the group comprising a high-pressure gas cylinder, vessel, tank, pipe, pump or component part suitable for applying said primer and said thermoplastic material by electrostatic powder deposition.

7. The process as defined in claim 1, wherein said first temperature comprises a temperature sufficient to bond said primer to said interior portion of said container.

8. The process as defined in claim 7, wherein said first temperature is between about 200° C. and 380° C.

9. The process as defined in claim 1, wherein said primer comprises a blend of powders derived from said thermoplastic material and other organic and inorganic materials, each with a different melting point and density.

10. The process as defined in claim 1, wherein said thermoplastic material is selected from the group consisting of ethylene chlorotrifluoroethylene (ECTFE), chlorotrifluoroethylene (CTFE), ethylene tetrafluoroethylene (ETFE), HTE, polyvinylidene fluoride (PVDF), fluorinated ethylene propylene (FEP), methylfluoroalkoxy (MFA), perfluoroalkoxy (PFA), copolymers and terpolymers of the aforementioned, polyamide, polyphenylsulfone (PPF), polyether-etherketone (PEEK), polyethylene, and polypropylene.

11. The process as defined in claim 1, wherein said second temperature is between about 150° C. to 320° C.

12. A process for applying a primer and a thermoplastic material to at least a portion of an interior surface of a container, said process comprising the steps of:
heating said portion of said interior surface of said container to a first temperature;
applying said primer to said portion of said interior surface of said cylinder by liquid dispersion;
heating said treated portion of said container to said first temperature to facilitate bonding of said primer to said treated surface of said container;
delivering said thermoplastic material by liquid dispersion to said treated portion of said container; and
bonding said thermoplastic material by heating said treated portion of said container to a second temperature.

13. The process as defined claim 12, further comprising the step of roughening said portion of said interior surface of said container.

14. The process as defined in claim 12, further comprising the step of cleaning said portion of said interior surface of said container to remove debris.

15. The process as defined in claim 12, wherein said container is selected from the group comprising a high-pressure gas cylinder, vessel, tank, pipe, pump or component part suitable for applying said primer and said thermoplastic material by liquid dispersion.

16. The process as defined in claim 12, wherein said first temperature comprises a temperature sufficient to bond said primer to said portion of said interior surface of said container.

17. The process as defined in claim 16, wherein said first temperature is between about 200° C. and 380° C.

18. The process as defined in claim 12, wherein said primer comprises a blend of powders derived from said thermoplastic material and other organic and inorganic materials, each with a different melting point and density.

19. The process as defined in claim 12, wherein said thermoplastic material is selected from the group consisting of ethylene chlorotrifluoroethylene (ECTFE), chlorotrifluoroethylene (CTFE), ethylene tetrafluoroethylene (ETFE), HTE, polyvinylidene fluoride (PVDF), fluorinated ethylene propylene (FEP), methylfluoroalkoxy (MFA), perfluoroalkoxy (PFA), copolymers and terpolymers of the aforementioned, polyamide, polyphenylsulfone (PPF), polyether-etherketone (PEEK), polyethylene, and polypropylene.

20. The process as defined in claim 12, wherein said second temperature is between about 150° C. to 320° C.

21. The process as defined in claim 12, wherein said liquid dispersion process is selected from the group consisting of conventional spraying, HVLP, airless liquid spraying, pressure pot liquid spraying and electrostatic liquid spraying.

22. A process for applying a primer and a thermoplastic material having a melting temperature to at least a portion of an interior surface of a container, said process comprising the steps of:
delivering said thermoplastic material by liquid dispersion to said portion of said interiorsurface of said container; and
bonding said thermoplastic material by heating said treated portion of said container to said melting temperature.

23. The process as defined claim 22, further comprising the step of roughening said portion of said interior surface of said container.

24. The process as defined in claim 22, further comprising the step of cleaning said portion of said interior surface of said container to remove debris.

25. The process as defined in claim 22, wherein said container is selected from the group comprising a high-pressure gas cylinder, vessel, tank, pipe, pump or component part suitable for applying said primer and said thermoplastic material by liquid dispersion.

26. The process as defined in claim 22, wherein said thermoplastic material is selected from the group consisting of ethylene chlorotrifluoroethylene (ECTFE), chlorotrifluoroethylene (CTFE), ethylene tetrafluoroethylene (ETFE), HTE, polyvinylidene fluoride (PVDF), fluorinated ethylene propylene (FEP), methylfluoroalkoxy (MFA), perfluoroalkoxy (PFA), copolymers and terpolymers of the aforementioned, polyamide, polyphenylsulfone (PPF), polyether-etherketone (PEEK), polyethylene, and polypropylene.

27. The process as defined in claim 22, wherein said melting temperature is between about 150° C. to 320° C.

28. The process as defined in claim 22, wherein said liquid dispersion process is selected from the group consisting of conventional spraying, HVLP, airless liquid spraying, pressure pot liquid spraying and electrostatic liquid spraying.

29. The process as defined in claim 22, further comprising the step of delivering a second application of said thermoplastic material by liquid dispersion to said treated portion of said container.

30. The process as defined in claim 29, further comprising the step of bonding said second application of said thermoplastic material by heating said treated portion of said container to said second temperature.
